(19) United States
(12) Patent Application Publication
(10) Pub. No.: US 2022/0275555 A1
(43) Pub. Date: Sep. 1, 2022

(54) AUTOMATIC LAUNDRY DISPENSING DEVICE IN CONTACT-FREE LAUNDRY SERVICE

(71) Applicant: Lifegoeson Company Corp., Seoul (CN)

(72) Inventor: Sung Woo CHO, Seoul (KR)

(73) Assignee: Lifegoeson Company Corp., Seoul (CN)

(21) Appl. No.: 17/748,078

(22) Filed: May 19, 2022

(30) Foreign Application Priority Data
May 20, 2021 (KR) 10-2021-0064946

(51) Int. Cl. D06F 33/30; D06F 93/00; D06F 95/00

(52) U.S. Cl. CPC D06F 33/30; D06F 93/00; D06F 95/00; D06F 2103/02

(57) ABSTRACT

The present invention relates to an automatic laundry dispensing device in a contact-free laundry service, including a laundry classification module configured to classify laundry that has been washed, a kicker module including at least one slot and configured to receive laundry classified as suitable for dispensing by the laundry classification module, a temporary accommodation module configured to accommodate laundry classified as unsuitable for dispensing by the laundry classification module, and a laundry reclassification module configured to resolve an inappropriate factor of the laundry accommodated in the temporary accommodation module and then transfer the laundry back to the kicker module.

### CROSS-REFERENCE TO RELATED APPLICATION

This application claims priority to and the benefit of Korean Patent Application No. 10-2021-0064946, filed on 2021 May 20, the disclosure of which is incorporated herein by reference in its entirety.

### BACKGROUND

### Field of the Invention

The present invention relates to an automatic laundry dispensing device in a contact-free laundry service.

### Discussion of Related Art

Washing to restore clothes to their original states by physically and chemically removing contaminants such as dirt and dust from the clothes is generally divided into two types that are wet cleaning in which contaminants are removed using water and detergent and dry cleaning in which contaminants are removed using organic solvents. Wet cleaning can be done easily at home, whereas dry cleaning requires special equipment and technology so that the dry cleaning is mainly performed professionally at a laundry, and the dry cleaning is effective for clothes that may be damaged or whose material shape may change by water or detergent.

Currently, in laundries, not only washing such as dry cleaning, but also wet cleaning and clothing repair are performed, and such laundries are becoming widespread and at the same time gradually being enlarged, specialized, and mechanized.

As laundry service methods performed in a general laundry, there are a method in which a customer visits a laundry, leaves laundry, and checks a laundry schedule, and a method in which a laundry's owner personally visits a customer's house to collect laundry and inform the customer of a laundry schedule.

In the above methods, the customer directly visits the laundry or the laundry's owner directly visits the customer's house. When the customer visits the laundry to leave laundry but the laundry's owner is not there for the reason of delivery, it is inconvenient for the customer to wait for the laundry's owner to return or to visit the laundry another time.

Further, there is a problem in that the laundry's owner has to visit each customer's house recklessly, resulting in loss of time and physical pain, and when the laundry's owner is delivering laundry, the laundry's owner cannot receive a request for laundry even when the customer visits the laundry, thereby causing economic loss.

Generally, there are laundries in shopping malls of apartments that constitute residential areas. For the convenience of the residents, the owners of the laundries visit the apartments after receiving phone calls and collect laundry, or go around hallways of each apartment at a set time and shout to collect laundry.

However, the above methods have disadvantages in that, since laundry collectors have to go around each apartment at a set time and shout, the laundry collectors have to exert a considerable amount of labor when the tenants of the apartments do not respond to the shout.

That is, in an apartment building including a large number of households, since all the residents take out their laundry at a time that is required by the tenant rather than at a time that is set by the laundry collector, the laundry collector should endure the inconvenience described above for the convenience of the residents.

Therefore, a method of leaving laundry in front of a front door of an apartment can be considered. Even in this case, there is a problem of loss of the laundry, or exposure of privacy due to the laundry being shown to outsiders.

Meanwhile, in a general laundry management method, when a laundry receives laundry from a customer, the laundry's worker writes customer information in a ledger by hand and issues an invoice.

Next, the laundry's worker attaches a number tag with an invoice number to the laundry, and after the washing is finished, the laundry's worker pre-marks a recognition code consisting of characters or symbols indicating a specific area, records the invoice number and identification code in the ledger, and hangs the laundry in the specific area.

In such a state, when a desired date or time comes and the customer visits the laundry with the invoice, the worker reads the ledger, visually checks the area in which the customer's laundry is hung, and then moves directly to the corresponding area to find the laundry and hand over the laundry to the customer.

However, in such a general laundry management method, in the case of a small business, it is possible to operate to a certain extent, whereas in the case of a large business, there is a problem in that it is difficult to manage laundry and customers, and a considerable amount of time is spent to find the corresponding laundry, thereby reducing work efficiency.

In addition, there is a problem of reducing space and time efficiency in receiving and dispensing laundry in a limited space when the number of pieces of laundry to be dispensed and the number of customers are large.

### SUMMARY OF THE INVENTION

The present invention is directed to providing an automatic laundry dispensing device in a contact-free laundry service, in which a problem of reducing space and time efficiency in receiving and dispensing laundry in a limited space when the number of pieces of laundry to be dispensed and the number of customers are large is solved.

According to an aspect of the present invention, there is provided an automatic laundry dispensing device in a contact-free laundry service, including a laundry classification module configured to classify laundry that has been washed, a kicker module including at least one slot and configured to receive laundry classified as suitable for dispensing by the laundry classification module, a temporary accommodation module configured to accommodate laundry classified as unsuitable for dispensing by the laundry classification module, and a laundry reclassification module configured to resolve an inappropriate factor of the laundry accommodated in the temporary accommodation module and then transfer the laundry back to the kicker module, wherein, when there is no barcode on the laundry that has been washed, when there is a barcode on the laundry that has been washed but the barcode cannot be recognized, or when there is a barcode on the laundry that has been washed and the barcode is recognizable but there is no slot to be accommodated in the kicker module, the laundry classification module transfers the laundry to the temporary accommodation module.

The laundry classification module may transfer only laundry having preset scheduled dispensing time information to the kicker module using scheduled dispensing time information of a plurality of pieces of laundry.

When the laundry classification module transfers the laundry to the temporary accommodation module because the laundry is all accommodated in the at least one slot of the kicker module, the kicker module may dispense the laundry accommodated at the moment when the slot, in which all the laundry to be dispensed is collected, is generated, and transmit information of the slot in which the laundry has been dispensed to the laundry reclassification module.

In the case in which the laundry classification module transfers the laundry to the temporary accommodation module because the laundry is all accommodated in the at least one slot of the kicker module, when there is no slot in which all the laundry to be dispensed to the kicker module is collected, a plurality of pieces of slot information may be listed in the order of the smallest total amount of laundry to be dispensed, and the laundry may be transferred to the laundry reclassification module.

In the case in which the laundry classification module transfers the laundry to the temporary accommodation module because the laundry is all accommodated in the at least one slot of the kicker module, when there is no slot in which all the laundry to be dispensed to the kicker module is collected, a plurality of pieces of slot information may be listed in the order in which the amount of laundry to be additionally transferred in order to be dispensed is small, and the laundry may be transferred to the laundry reclassification module.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating a contact-free laundry service system according to an embodiment of the present invention;

FIG. 2 is a block diagram illustrating a structure of a notification system of a contact-free laundry service system according to an embodiment of the present invention;

FIG. 3 illustrates a state in which a laundry bag for implementing a contact-free laundry service system according to an embodiment of the present invention is installed to be locked in a door of the user's house; and

FIG. 4 illustrates a structure of an automatic laundry dispensing device in a contact-free laundry service according to an embodiment of the present invention.

### DETAILED DESCRIPTION OF EXEMPLARY EMBODIMENTS

Embodiments of the present invention are exemplified for the purpose of describing the technical spirit of the present invention. The scope of the present invention is not limited to the embodiments presented below or specific descriptions of these embodiments.

Unless otherwise defined, all terms including technical and scientific terms used herein have the same meaning as commonly understood by one of ordinary skill in the art to which the present invention pertains. All terms used herein are selected for the purpose of more clearly describing the present invention and not to limit the scope of the present invention.

It should be understood that the terms such as “comprising,” “including,” “having,” etc. when used herein, are open-ended terms denoting the possibility of including other embodiments, unless otherwise stated in the phrase or sentence in which the terms are included.

In this specification, the singular forms include the plural forms unless the context clearly indicates otherwise, and are also applied to the singular forms described in the appended claims.

The terms such as “first” or “second” as used herein are used to distinguish a plurality of components from each other, and do not limit the order or importance of the components.

The term “unit” or “part” used in the present invention refers to software or hardware components such as field-programmable gate arrays (FPGAs) and application specific integrated circuits (ASICs). However, the “unit” or “part” is not limited to software or hardware. The unit” or “part” may be configured to reside on an addressable storage medium or may be formed to be executed by at least one processor.

Therefore, examples of the “unit” or “part” may include components such as software components, object-oriented software components, class components, and task components, processes, functions, properties, procedures, subroutines, segments in program code, drivers, firmware, microcode, circuits, data, databases, data structures, tables, arrays, and parameters. Components and functions provided in the “unit” or “part” may be combined into a smaller number of components or may be further separated into additional components.

The expression “based on” is used to describe one or more factors that affect the act or action of a decision or determination, which is described in a phrase or sentence in which the expression is included, and this expression does not exclude additional factors that affect the act or action of a decision or determination.

It should be understood that when a component is referred to as being “connected” or “coupled” to another component, the component may be directly connected or coupled to another component, or the component may be connected or coupled to another component with a new component interposed therebetween.

Hereinafter, the embodiments of the present invention will be described with reference to the accompanying drawings.

In the accompanying drawings, the same reference numerals are assigned to identical or corresponding components. Further, in the description of the embodiments below, redundant descriptions of the identical or corresponding components will be omitted. However, even when descriptions regarding the components are omitted, it is not intended that such components are not included in any embodiment.

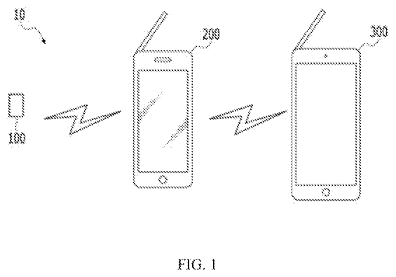

FIG. 1 is a block diagram illustrating a laundry delivery and collection system according to an embodiment of the present invention.

Referring to FIG. 1, a laundry collection and management system 10 according to the embodiment of the present invention includes an electronic tag unit 100, a terminal 200, and a service provider terminal 300. Not all of the components of the laundry collection and management system 10 illustrated in FIG. 1 are essential components, and the laundry collection and management system 10 may be implemented by more components than the components illustrated in FIG. 1 or may also be implemented by fewer components than the components illustrated in FIG. 1.

The electronic tag unit 100 includes collection tagging information including a message, which is transmitted from a customer requesting collection of laundry to a business operator.

Further, the electronic tag unit 100 includes a near-field communication (NFC) tag, a barcode, a quick response (QR) code, a radio-frequency identification (RFID) tag, etc.

Further, the electronic tag unit 100 may be configured to be attachable to and detachable from an interior (e.g., living room, room, kitchen, home appliance, etc.) of a house where the customer resides, a vehicle of the customer, or the like.

Further, the electronic tag unit 100 may include customer information corresponding to the customer.

The terminal 200 may be one of various terminals such as a smartphone, a portable terminal, a mobile terminal, a personal digital assistant (PDA), a portable multimedia player (PMP), a telematics terminal, a navigation terminal, a personal computer (PC), a notebook computer, a slate PC, a tablet PC, an ultrabook, a wearable device (including, for example, a watch-type terminal (smartwatch), a glasses-type terminal (smart glasses), a head-mounted display (HMD), etc.), a WiBro terminal, an Internet Protocol television (IPTV) terminal, a smart TV, a digital broadcasting terminal, a TV, a three-dimensional (3D) TV, a home theater system, an audio-visual navigation (AVN) terminal, an audio/video (A/V) system, a flexible terminal, and the like.

Further, the terminal 200 may recognize (or obtain) the collection tagging information included in the electronic tag unit 100 through tagging with the electronic tag unit 100.

That is, after the customer puts a laundry storage bag (not illustrated) with laundry to be left for a laundry service provider, into a box for collection of laundry (not illustrated) provided at a pre-designated location, the terminal 200 tags to recognize the collection tagging information through tagging with the electronic tag unit 100.

Here, the laundry storage bag may be a bag that is used by the customer to leave the laundry for the laundry service provider or to receive the laundry.

Further, the box for collection of laundry is provided at a pre-designated location in the neighborhood.

Further, when the customer wants to leave laundry for the laundry service provider, the customer puts the laundry into the laundry storage bag and then stores (or puts) the laundry storage bag in the box for collection of laundry.

The laundry service provider collects the laundry storage bag stored inside the box for collection of laundry, and proceeds to wash the laundry stored in the laundry storage bag.

Further, the laundry service provider puts the washed laundry into the laundry storage bag, and delivers the washed laundry directly to the customer or delivers the washed laundry to the customer using the box for collection of laundry.

Further, the terminal 200 generates laundry request information on the basis of the collection tagging information. Here, the laundry request information includes the collection tagging information, identification information of the terminal 200, identification information of the box for collection of laundry, customer information, laundry input date and time information (including, for example, date information, time information, etc.), and the like. In this case, the customer information includes an address, contact information, a name of the customer, and the like. Further, the laundry input date and time information includes date and time information of a time point at which the collection tagging information is recognized or a time point at which the laundry request information is generated.

Further, the terminal 200 transmits the generated laundry request information to the service provider terminal 300.

Further, the terminal 200 receives laundry collection confirmation information transmitted from the service provider terminal 300 in response to the transmitted laundry request information.

Further, the terminal 200 outputs the received laundry collection confirmation information.

Further, the terminal 200 receives delivery schedule information transmitted from the service provider terminal 300. Here, the delivery schedule information includes the identification information of the box for collection of laundry, which is included in the laundry request information corresponding to the corresponding laundry left by the customer (or user) of the terminal 200, location information (or map information) corresponding to the identification information of the box for collection of laundry, scheduled delivery date information, and the like.

Further, the terminal 200 outputs the received delivery schedule information.

Further, when the customer cannot receive the corresponding laundry on the delivery schedule included in the outputting delivery schedule information or when the customer wants to change the delivery schedule, the terminal 200 generates delivery schedule change information. Here, the delivery schedule change information includes information on a change date to be changed, the identification information of the terminal 200, the identification information of the box for collection of laundry, and the like.

Further, the terminal 200 transmits the generated delivery schedule change information to the service provider terminal 300.

The service provider terminal 300 may be one of various terminals such as a smartphone, a portable terminal, a mobile terminal, a PDA, a PMP, a telematics terminal, a navigation terminal, a PC, a notebook computer, a slate PC, a tablet PC, an ultrabook, a wearable device, a WiBro terminal, an IPTV terminal, a smart TV, a digital broadcasting terminal, a TV, a 3D TV, a home theater system, an AVN terminal, an A/V system, a flexible terminal, and the like.

Further, the service provider terminal 300 receives the laundry request information transmitted from the terminal 200.

Further, the service provider terminal 300 outputs the received laundry request information.

Therefore, the business operator (or laundry service provider) who uses the service provider terminal 300 may confirm a laundry request from the customer.

Further, the service provider terminal 300 accumulates (or generates/obtains) count information of laundry collected for each box for collection of laundry on the basis of the received laundry request information. In this case, the service provider terminal 300 may accumulate count information (or count information of laundry collected for each box for collection of laundry) for each box for collection of laundry on the basis of laundry request information transmitted from one or more other terminals (not illustrated) in addition to the terminal 200.

Here, the service provider terminal 300 stores the location information (or map information) corresponding to the identification information of the box for collection of laundry.

Further, the service provider terminal 300 generates laundry collection confirmation information indicating that the laundry request information transmitted from the terminal 200 has been normally received (or that the laundry request from the customer has been confirmed).

Further, the service provider terminal 300 transmits the generated laundry collection confirmation information to the terminal 200 in response to the received laundry request information.

Further, when the count information accumulated for each box for collection of laundry exceeds a preset value, the service provider terminal 300 generates alarm information. Here, the alarm information includes the identification information of the box for collection of laundry corresponding to the count information that exceeds the preset value.

Further, the service provider terminal 300 outputs the generated alarm information.

Further, after the washing of the corresponding laundry is completed, the service provider terminal 300 generates delivery schedule information. Here, the delivery schedule information includes the identification information of the box for collection of laundry included in the laundry request information corresponding to the corresponding laundry, the location information (or map information) corresponding to the identification information of the box for collection of laundry, the scheduled delivery date information, and the like.

Further, the service provider terminal 300 transmits the generated delivery schedule information to the corresponding terminal 200 on the basis of the identification information of the terminal 200 included in the laundry request information corresponding to the corresponding laundry.

That is, when the business operator places the laundry that has been washed in the box for collection of laundry, the service provider terminal 300 generates the delivery schedule information and transmits the generated delivery schedule information to the terminal 200.

Further, when the business operator wants to directly deliver the laundry that has been washed to the customer at a pre-designated time point, the service provider terminal 300 generates the delivery schedule information and transmits the generated delivery schedule information to the terminal 200.

Further, the service provider terminal 300 receives the delivery schedule change information transmitted from the terminal 200 in response to the transmitted delivery schedule information.

Further, the service provider terminal 300 outputs the received delivery schedule change information.

Further, the service provider terminal 300 updates (or modifies/changes) the delivery schedule information on the basis of the received delivery schedule change information.

In the embodiment of the present invention, the service provider terminal 300 is described as directly communicating with the terminal 200, the present invention is not limited thereto, and a server (not illustrated) provided between the terminal 200 and the service provider terminal 300 may be further included.

As described above, when the server is provided between the terminal 200 and the service provider terminal 300, some functions of the service provider terminal 300 may be performed by the server.

That is, the server may receive laundry request information transmitted from each of one or more terminals 200, and accumulate count information of laundry collected for each box for collection of laundry on the basis of the received laundry request information, and when the accumulated count information exceeds a preset value, the server may generate alarm information and transmit the generated alarm information to the service provider terminal 300.

Further, the server may transmit delivery schedule information transmitted from the service provider terminal 300 to the corresponding terminal 200, and transmit delivery schedule change information transmitted from the terminal 200 to the service provider terminal 300.

As described above, when the customer wants to request laundry to a laundry in a convenient way using a box for collection of laundry provided at a preset location, the service provider terminal may be notified of a laundry request status through an electronic tag.

Further, as described above, the laundry service provider may easily check the number of pieces of requested laundry using the box for collection of laundry provided at the preset location, and may collect the laundry at an appropriate time.

Further, as described above, the customer may easily check the delivery schedule of the laundry, and may request changing of the delivery schedule as necessary.

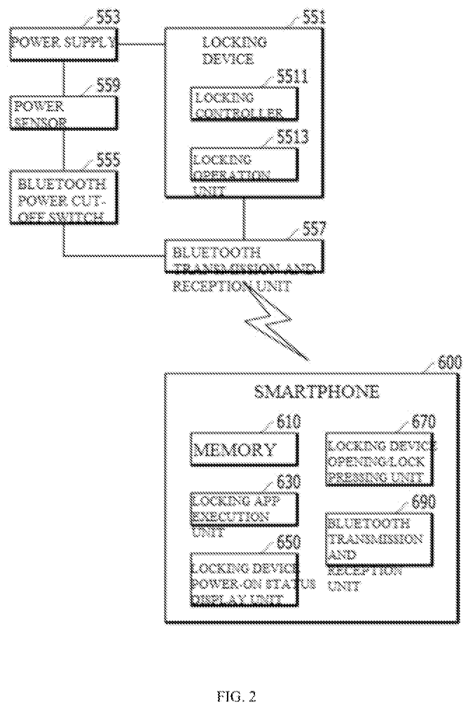

FIG. 2 is a block diagram illustrating a structure of a notification system of a laundry delivery and collection system according to an embodiment of the present invention.

Referring to FIG. 2, it is possible to solve the essential problem of the present invention to allow, in a state in which a laundry bag according to the embodiment of the present invention is placed in front of a door of a user's house, when the laundry bag can be easily locked and unlocked using the user's smartphone, the user to receive laundry at any time.

Therefore, the laundry bag according to the embodiment of the present invention may include a locking device 551, a power supply 553 that supplies power to the locking device 551, a power sensor 559 provided to detect the power remaining in the power supply 553, and a Bluetooth transmission and reception unit 557 that transmits/receives a signal to/from a user's smartphone 600.

Further, the locking device 551 may include a locking controller 5511 that controls the locking device, and a locking operation unit 5513 that performs a locking operation according to a control signal of the locking controller 5511.

The power sensor 559 may serve to detect the power remaining in the power supply 553 and transmit information on the detected power of the power supply 553 to the Bluetooth transmission and reception unit 557, and the power information of the power supply 553 transmitted to the Bluetooth transmission and reception unit 557 may be transmitted to a Bluetooth transmission and reception unit 690 of the smartphone 600.

In this way, when the user executes an app, the power information of the power supply 553 transmitted to the user's smartphone 600 may be transmitted in real time to a server of a manager via the Internet, and thus the manager may manage the power remaining in the power supply 553 of the laundry bag in real time.

Meanwhile, the laundry bag of the present invention may further include a Bluetooth power cut-off switch 555 capable of cutting off the power, which is transmitted from the power supply 553 to the locking device 551 and the Bluetooth transmission and reception unit 557.

The Bluetooth power cut-off switch 555 may normally cut off the power transmitted to the locking device 551 and the Bluetooth transmission and reception unit 557, and thus the power transmitted to the locking device 551 or the Bluetooth transmission and reception unit 557 may be cut off in a standby state, thereby minimizing power consumption in the standby state.

Briefly describing an embodiment in which the locking device of the laundry bag of the present invention is operated, the user may execute a locking app execution unit 630 provided in the user's smartphone 600 to execute a lock app for controlling the locking device of the laundry bag, and in this case, the user may check whether power is applied to the locking device using a locking device power-on status display unit 650.

When the user operates a locking device opening/lock pressing unit 670, a control signal is transmitted to the Bluetooth transmission and reception unit 557 of the locking device through the Bluetooth transmission and reception unit 690 of the smartphone.

When the control signal is transmitted to the Bluetooth transmission and reception unit 557 of the locking device, the Bluetooth power cut-off switch 555 is released, the locking device comes out of the standby state, the control signal is transmitted to the locking controller 5511 of the locking device 551, and the locking controller 5511 operates the locking operation unit 5513 according to the control signal.

In this way, the lock of the laundry bag according to the embodiment of the present invention may be unlocked or set by simply manipulating the user's smartphone 600.

FIG. 2 is a block diagram illustrating a configuration of a laundry bag and a smartphone that are used in a contact-free laundry service system according to an embodiment of the present invention.

Referring to FIG. 2, it is possible to solve the essential problem of the present invention to allow, in a state in which a laundry bag according to the embodiment of the present invention is placed in front of a door of a user's house, when the laundry bag can be easily locked and unlocked using the user's smartphone, the user to receive laundry at any time.

Therefore, the laundry bag according to the embodiment of the present invention may include a locking device 551, a power supply 553 that supplies power to the locking device 551, a power sensor 559 provided to detect the power remaining in the power supply 553, and a Bluetooth transmission and reception unit 557 that transmits/receives a signal to/from a user's smartphone 600.

Further, the locking device 551 may include a locking controller 5511 that controls the locking device, and a locking operation unit 5513 that performs a locking operation according to a control signal of the locking controller 5511.

The power sensor 559 may serve to detect the power remaining in the power supply 553 and transmit information on the detected power of the power supply 553 to the Bluetooth transmission and reception unit 557, and the power information of the power supply 553 transmitted to the Bluetooth transmission and reception unit 557 may be transmitted to a Bluetooth transmission and reception unit 690 of the smartphone 600.

In this way, when the user executes an app, the power information of the power supply 553 transmitted to the user's smartphone 600 may be transmitted in real time to a server of a manager via the Internet, and thus the manager may manage the power remaining in the power supply 553 of the laundry bag in real time.

Meanwhile, the laundry bag of the present invention may further include a Bluetooth power cut-off switch 555 capable of cutting off the power, which is transmitted from the power supply 553 to the locking device 551 and the Bluetooth transmission and reception unit 557.

The Bluetooth power cut-off switch 555 may normally cut off the power transmitted to the locking device 551 and the Bluetooth transmission and reception unit 557, and thus the power transmitted to the locking device 551 or the Bluetooth transmission and reception unit 557 may be cut off in a standby state, thereby minimizing power consumption in the standby state.

Briefly describing an embodiment in which the locking device of the laundry bag of the present invention is operated, the user may execute a locking app execution unit 630 provided in the user's smartphone 600 to execute a lock app for controlling the locking device of the laundry bag, and in this case, the user may check whether power is applied to the locking device using a locking device power-on status display unit 650.

When the user operates a locking device opening/lock pressing unit 670, a control signal is transmitted to the Bluetooth transmission and reception unit 557 of the locking device through the Bluetooth transmission and reception unit 690 of the smartphone.

When the control signal is transmitted to the Bluetooth transmission and reception unit 557 of the locking device, the Bluetooth power cut-off switch 555 is released, the locking device comes out of the standby state, the control signal is transmitted to the locking controller 5511 of the locking device 551, and the locking controller 5511 operates the locking operation unit 5513 according to the control signal.

In this way, the lock of the laundry bag according to the embodiment of the present invention may be unlocked or set by simply manipulating the user's smartphone 600.

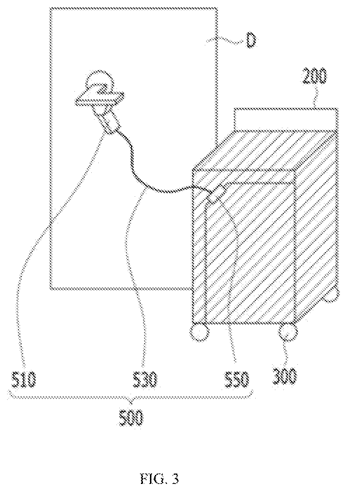

FIG. 3 illustrates a state in which a laundry bag for implementing a contact-free laundry service system according to an embodiment of the present invention is installed to be locked in a door of the user's house.

Referring to FIG. 3, the laundry bag of the present invention may include a wire 530 which is connected to a laundry locking device 550 in a state in which the exposure of laundry to the outside is restricted by the laundry locking device 550, and a handle locking device 510 which is connected to the wire 530 to lock the wire 530 in a handle provided on a door D of the user's house.

As described above, because modern life is so busy, it is sometimes necessary to leave the laundry that has been washed in front of the door D of the user's house.

In this case, there is a possibility that the laundry bag placed in front of the door may be lost, and furthermore, when there is no locking device for laundry itself, there is also a possibility that the laundry accommodated in the laundry bag may be lost.

In order to prevent the above problem, the handle locking device 510 serves to lock the connection between the laundry bag and the door of the user's house, and the laundry locking device 550 serves to lock the laundry bag itself.

Accordingly, it is possible to prevent the problem in which the laundry bag and the laundry accommodated in the laundry bag are lost.

As described above, the user may be able to lock and unlock the laundry locking device 550 and the handle locking device 510 using a smartphone.

More specifically, the laundry locking device 550 may communicate with the user's smartphone through Bluetooth communication, and thus the user or a laundry collector may lock or unlock the laundry locking device 550 using a mobile communication device capable of communicating with the laundry locking device 550.

Further, in order to enable locking and unlocking of the laundry locking device 550 even in a situation in which communication with the laundry locking device 550 is unstable or the laundry locking device 550 cannot be operated due to lack of power, a physical key may be additionally provided.

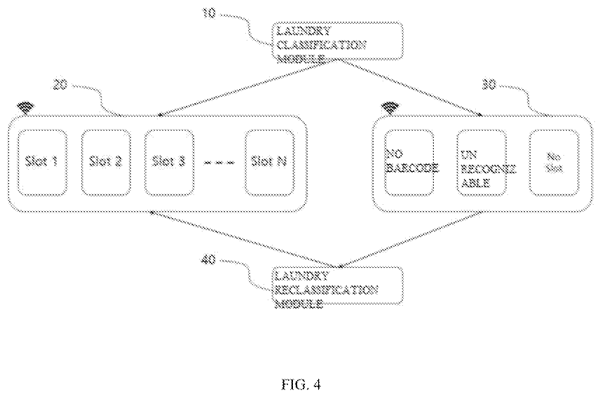

FIG. 4 illustrates a structure of an automatic laundry dispensing device in a contact-free laundry service according to an embodiment of the present invention.

Referring to FIG. 4, the automatic laundry dispensing device in the contact-free laundry service according to the embodiment of the present invention may include a laundry classification module 10, a kicker module 20 configured to accommodate laundry classified as suitable for dispensing by the laundry classification module 10, a temporary accommodation module 30 configured to accommodate laundry classified as unsuitable for dispensing by the laundry classification module 10, and a laundry reclassification module 40 configured to resolve an inappropriate factor of the laundry accommodated in the temporary accommodation module 30 and then transfer the laundry back to the kicker module 20.

Meanwhile, when there is no barcode on laundry that has been washed, when there is a barcode on the laundry that has been washed but the barcode cannot be recognized, or when there is a barcode on the laundry that has been washed and the barcode is recognizable but there is no slot to be accommodated in the kicker module 20, the laundry classification module 10 may transfer the laundry to the temporary accommodation module 30.

The laundry classification module 10 may transfer only laundry having preset scheduled dispensing time information to the kicker module using scheduled dispensing time information of a plurality of pieces of laundry.

More specifically, in the contact-free laundry service according to the embodiment of the present invention, washing may be completed within one day from a date of the user's request for laundry collection and the laundry may be delivered, and in this case, the scheduled dispensing time of the laundry may be set based on the date of the user's request for laundry collection.

For example, when the date of the user's request for laundry collection ranges from 5 pm to 12 pm on Jan. 1, 2021, an expected dispensing date at which the user's laundry should be collected and dispensed may be set to 5 pm on Jan. 2, 2021, and in consideration of the moving time, the expected dispensing date may be set in the laundry classification module 10 as 1 pm on Jan. 2, 2021.

That is, the laundry classification module 10 may transfer only the laundry of the users that should be dispensed at 5 pm on Jan. 2, 2021 to the kicker module 20.

Meanwhile, the laundry classification module 10 transfers only the laundry having the preset scheduled dispensing time information to the kicker module using expected dispensing date information of a plurality of pieces of laundry. However, when there is a slot remaining in the kicker module 20, the laundry classification module 10 may be set to transfer the laundry expected to be dispensed next to the kicker module 20.

When the laundry classification module 10 transfers the laundry to the temporary accommodation module 30 because the laundry is all accommodated in at least one slot of the kicker module 20, the kicker module 20 may dispense the laundry accommodated at the moment when the slot, in which all the laundry to be dispensed is collected, is generated, and transmit information of the slot in which the laundry has been dispensed to the laundry reclassification module 40.

Further, in the case in which the laundry classification module 10 transfers the laundry to the temporary accommodation module 30 because the laundry is all accommodated in at least one slot of the kicker module 20, when there is no slot in which all the laundry to be dispensed to the kicker module 20 is collected, a plurality of pieces of slot information may be listed in the order of the smallest total amount of laundry to be dispensed, and the laundry may be transferred to the laundry reclassification module 40.

Meanwhile, in the case in which the laundry classification module 10 transfers the laundry to the temporary accommodation module 30 because the laundry is all accommodated in at least one slot of the kicker module 20, when there is no slot in which all the laundry to be dispensed to the kicker module 20 is collected, a plurality of pieces of slot information may be listed in the order in which the amount of laundry to be additionally transferred in order to be dispensed is small, and the laundry may be transferred to the laundry reclassification module 40.

As described above, in the automatic laundry dispensing device in the contact-free laundry service according to the embodiment of the present invention, by maximally efficiently utilizing a limited space of the kicker module 20, which is a waiting place for laundry, the kicker module 20 may be controlled to operate without stopping as much as possible in the limited space.

Although the method has been described through specific embodiments, the method may be implemented as computer readable code in a computer-readable recording medium. The computer-readable recording medium includes all types of recording media in which data that can be read by a computer system is stored. Examples of the computer-readable recording medium may include a read only memory (ROM), a random access memory (RAM), a compact disc read only memory (CD-ROM), a magnetic tape, a floppy disk, an optical data storage device, and the like.

Further, computer-readable recording media may be distributed in computer systems connected via a network and stored and executed as code that can be read in a distributed manner. Also, functional programs, code and code segments for implementing the present invention may be easily construed by programmers skilled in the art to which the present invention pertains.

According to the present invention, an automatic laundry dispensing device in a contact-free laundry service, in which a problem of reducing space and time efficiency in receiving and dispensing laundry in a limited space when the number of pieces of laundry to be dispensed and the number of customers are large, can be provided.

Although the technical spirit of the present invention has been described with reference to examples illustrated in some embodiments and the accompanying drawings, it should be understood that various substitutions, modifications, and alterations can be made by those of ordinary skill in the art to which the present invention pertains without departing from the spirit and scope of the present invention. Further, such substitutions, modifications, and alterations are intended to fall within the scope of the appended claims.

What is claimed is:

1. An automatic laundry dispensing device in a contact-free laundry service, the automatic laundry dispensing device comprising:
a laundry classification module configured to classify laundry that has been washed;
a kicker module including at least one slot and configured to receive laundry classified as suitable for dispensing by the laundry classification module;
a temporary accommodation module configured to accommodate laundry classified as unsuitable for dispensing by the laundry classification module; and
a laundry reclassification module configured to resolve an inappropriate factor of the laundry accommodated in the temporary accommodation module and then transfer the laundry back to the kicker module,
wherein, when there is no barcode on the laundry that has been washed, when there is a barcode on the laundry that has been washed but the barcode cannot be recognized, or when there is a barcode on the laundry that has been washed and the barcode is recognizable but there is no slot to be accommodated in the kicker module, the laundry classification module transfers the laundry to the temporary accommodation module.

2. The automatic laundry dispensing device of claim 1, wherein the laundry classification module transfers only laundry having preset scheduled dispensing time information to the kicker module using scheduled dispensing time information of a plurality of pieces of laundry.

3. The automatic laundry dispensing device of claim 1, wherein, when the laundry classification module transfers the laundry to the temporary accommodation module because the laundry is all accommodated in the at least one slot of the kicker module, the kicker module dispenses the laundry accommodated at the moment when the slot, in which all the laundry to be dispensed is collected, is generated, and transmits information of the slot in which the laundry has been dispensed to the laundry reclassification module.

4. The automatic laundry dispensing device of claim 3, wherein, in a case in which the laundry classification module transfers the laundry to the temporary accommodation module because the laundry is all accommodated in the at least one slot of the kicker module, when there is no slot in which all the laundry to be dispensed to the kicker module is collected, a plurality of pieces of slot information are listed in the order of the smallest total amount of laundry to be dispensed, and the laundry is transferred to the laundry reclassification module.

5. The automatic laundry dispensing device of claim 3, wherein, in a case in which the laundry classification module transfers the laundry to the temporary accommodation module because the laundry is all accommodated in the at least one slot of the kicker module, when there is no slot in which all the laundry to be dispensed to the kicker module is collected, a plurality of pieces of slot information are listed in the order in which the amount of laundry to be additionally transferred in order to be dispensed is small, and the laundry is transferred to the laundry reclassification module.
